(19) United States
(12) Patent Application Publication
(10) Pub. No.: US 2008/0012694 A1
(43) Pub. Date: Jan. 17, 2008

(54) Method For Preventing False Triggering Of A Passive Access System In The Motor Vehicle Domain

(76) Inventors: Aytac Daghan, Regensburg (DE); Franz Plattner, Arnschwang (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/569,318

(22) PCT Filed: Apr. 21, 2005
(86) PCT No.: PCT/EP05/51781

§ 371 Date: Aug. 16, 2007

(30) Foreign Application Priority Data
May 17, 2004 (DE) 10 2004 024 387.5

(51) Int. Cl. G07C 9/00

(52) U.S. Cl. 340/426.36

(57) ABSTRACT

A passive motor vehicle access system has at least one handle on the vehicle and at least one capacitive sensor situated in the vicinity of the handle which triggers a data identification interrogation of a data carrier in the user's possession, if the handle is actuated. A method comprises: determination of the number of cases of negative data identification that have already been carried out during a pre-determined time period; comparison of the determined number of negative identification cases with a pre-determined threshold value; and additional data identification interrogation, if the number of negative data identification cases is less than the pre-determined threshold value, or transmission of a new referencing command signal to the capacitive sensor or sensors in order to obtain a new reference for the latter, if the number of negative data identification cases is equal to the pre-determined threshold value.

### CROSS-REFERENCE TO RELATED APPLICATIONS

This application is a U.S. national stage application of International Application No. PCT/EP2005/051781 filed Apr. 21, 2005, which designates the United States of America, and claims priority to German application number DE 10 2004 024 387.5 filed May 17, 2004, the contents of which are hereby incorporated by reference in their entirety.

### TECHNICAL FIELD

The present invention relates to a method for preventing false triggering of a passive access system in the motor vehicle domain, in particular of a passive access system having a manually operated grip on the vehicle side and a capacitive sensor that is situated in the vicinity of said grip, is linked to a central control unit, and triggers a data identification interrogation of a data carrier associated with the operator by the central control unit when the manually operated grip is operated.

### BACKGROUND

Although applicable to any functions integrated in a vehicle, the present invention and the issues underlying it will be explained in more detail with reference to a locking mechanism or, as the case may be, a passive locking system of a vehicle door.

It is known in the case of locking systems of the above-cited type how to allow a person access to, for example, a motor vehicle by way of a data interrogation of a data carrier, for instance a key card, with said data interrogation being triggered by means of a mechanical switch attached to the motor vehicle or of a sensor which, for example, belongs to a photoelectric barrier and is installed on a door handle or at least in its vicinity. The person desiring access triggers the data carrier's data interrogation by a control unit in a motor vehicle by operating a manually operated grip, expressed more precisely by moving the door handle or by crossing a photoelectric barrier with a hand, with the triggered pulse being passed on by the control unit to a transmitter that conveys the data interrogation to the data carrier. The data carrier receives the data interrogation instruction and passes it on to a data unit that forwards the requested data to a transmitter. The transmitter then conveys the data once more via the send/receive unit on the vehicle side to the control unit in the motor vehicle, which unit will issue an instruction to release the locking system in the event of positive data recognition.

The publication DE 196 17 038 C2 describes a locking system wherein at least one electrode is installed in the manually operated grips of the motor vehicle's door handles and a counter-electrode, which can also be the door per se, is located in the part of the vehicle door opposite the manually operated grip. If an electric field is established between the two electrodes, that can advantageously already be used to sense the wish on the part of a person reaching for a manually operated grip located on the door to gain access. The way in which that is achieved according to DE 196 17 038 C2 is that a hand reaching for a manually operated grip located on the door will induce a change in the capacitance established between the two electrodes already while said hand is approaching. The hand's particular function therein lies in altering the dielectric between the electrode on the manually operated grip side and the counter-electrode on the door side by replacing a part of the ambient air with the hand's dielectric, thereby producing cumulatively a different overall dielectric. Electronic circuitry that registers the change in capacitance and transforms said change into an instruction pulse is located in, for example, the manually operated grip of the door handle. The instruction pulse generated by said electronic circuitry triggers interrogating of the data carrier associated with the operator in a central control unit, as already explained above.

What, though, has proved disadvantageous about this approach according to the prior art is that false triggering of the above-cited locking system will occur in the event of permanent changes to the ambient air or, as the case may be, overall dielectric due to, for example, rain, snow, or slush in the vicinity of the capacitive sensors. After triggering, the sensor must remain static for a predetermined length of time to be able to detect whether the release conditions, for example of the fingers placed on the manually operated grip, are still present. As a consequence of the capacitive sensor's temporary static characteristic there will be cyclic activity on the part of the connected control devices of a passive access system of said type in the event of false triggering due to, say, rain, snow, or slush because the control units will launch search sequences in order to authenticate possibly present data carriers, for example a key card, associated with the operator. To be able to detect operating of the manually operated grip or, as the case may be, an end of an operating action, the sensor must not be able to accommodate itself to operating of said type. Owing to the cyclic activity on the part of the control unit or, as the case may be, control units, that will lead to increased power consumption, as a result of which the battery may discharge overnight particularly when it is raining or snowing. In the morning the owner of the motor vehicle will then be unable to open it electronically, let alone start it.

DE 197 45 149 C2 discloses a passive access system in the motor vehicle domain having a capacitive sensor which is linked to a central control unit and triggers a data identification interrogation of a data carrier associated with the operator when the manually operated grip is operated.

It is known from DE 195 32 744 C2, DE 146 12 026 C2, and EP 785 114 A2 how to register the number of cases of data identification that have occurred and compare said number with a predetermined threshold value.

Finally, DE 196 10 275 C2 discloses how, by means of the central control unit, to register the number of cases of negative data identification having already occurred and compare said number with a preset threshold value.

Thus the approach in the prior art is to deactivate the capacitive sensor(s) automatically as a function of a predetermined length of time and as a function of an actuating operation. The locking system will consequently no longer be capable of functioning so that the motor vehicle user will encounter a deactivated locking system. Considerable customer dissatisfaction will be the result.

### SUMMARY

There exists a need for a method and system for preventing false triggering of a passive access system, in particular in the presence of rain, snow, or slush, without having to totally deactivate the locking system or access system.

A method for preventing false triggering of a passive access system in the motor vehicle domain, with said access system having at least one manually operated grip on the vehicle side and at least one capacitive sensor that is situated in the vicinity of said manually operated grip, is linked to a central control unit, and triggers a data identification interrogation of a data carrier associated with the operator by the central control unit when the manually operated grip is operated, may comprise the following method steps: registering the number of cases of negative data identification having already occurred during a predetermined length of time by the central control unit; comparing the registered number of cases of negative data identification with a predetermined threshold value by the central control unit; and having a further data identification interrogation performed by the central control unit if the registered number of cases of negative data identification is below the predetermined threshold value or having a re-referencing instruction signal sent by the central control unit to the at least one capacitive sensor for the purpose of re-referencing the same if the registered number of cases of negative data identification equals the predetermined threshold value.

In an embodiment, the predetermined threshold value can be pre-stored in a storage device linked to the central control unit. In an embodiment, the predetermined threshold value can be 2 or 3. In an embodiment, a re-referencing of the at least one capacitive sensor can be ordered by the central control unit during the static phase of operating the manually operated grip. In an embodiment, on receiving a re-referencing instruction signal from the central control unit the at least one capacitive sensor may recalibrate its zero position itself. In an embodiment, a re-referencing instruction signal may be sent by the central control unit to the at least one capacitive sensor for the purpose of re-referencing the same each time a door contact condition changes. In an embodiment, exterior mirrors may be folded in, a door locking device activated, side windows closed, and/or further changes in the motor vehicle's condition may be effected in the case of positive data identification when the manually operated grip is operated for the purpose of closing a vehicle door. In an embodiment, exterior mirrors may be folded out, a door locking device deactivated, side windows opened, and/or further changes in the motor vehicle's condition may be effected in the event of a case of positive data identification when the manually operated grip is operated for the purpose of opening the vehicle door. In an embodiment, a plurality of capacitive sensors may be provided in the motor vehicle, with preferably in each case one sensor being located on each door, each handle flap, or suchlike. In an embodiment, following operating of the manually operated grip and associated triggering of a data identification interrogation, a check may be carried out by the central control unit to determine if there are any unused data carriers belonging to the operator in the motor vehicle, with, if there are, said data carriers being blanked and not taken into account during further method steps.

### BRIEF DESCRIPTION OF THE DRAWINGS

The invention is explained in more detail below with the aid of the exemplary embodiments shown in the schematic figures of the drawing, in which:

FIG. 1 shows a schematic view of a motor vehicle having an integrated passive access system according to an exemplary embodiment of the present invention;

FIG. 2 shows a lateral cross-sectional view of a manually operated grip and of a part of a vehicle door according to an exemplary embodiment of the present invention; and

FIG. 3 is a schematic block diagram of an inventive method flow according to a preferred exemplary embodiment of the present invention.

Unless indicated otherwise, identical or, as the case may be, functionally identical components have been assigned the same reference numerals in the figures in the drawing.

### DETAILED DESCRIPTION

The idea underlying the present invention is for the inventive method to exhibit the following method steps: By means of the central control unit, registering the number of cases of negative data identification having already occurred during a predetermined length of time; by means of the central control unit, comparing the registered number of cases of negative data identification with a predetermined threshold value; and having a further data identification interrogation performed by the central control unit if the registered number of cases of negative data identification is below the predetermined threshold value or having a re-referencing instruction signal sent by the central control unit to the capacitive sensor for the purpose of re-referencing the same if the registered number of cases of negative data identification equals the predetermined threshold value.

The present invention thus offers the advantage over the known approaches to a solution according to the prior art that the capacitive sensor will, through said re-referencing performed independently when a predetermined number of negative data interrogations have already taken place, assume its idle condition in which the power consumption is only low. The system will thus retain its full functioning capability even in the presence of rain or snow during a prolonged period of non-operation because false triggering will result in increased power consumption only for a predetermined length of time when no identification provider associated with the motor vehicle is in its vicinity.

According to different embodiments, the predetermined threshold value is pre-stored in a storage device. The storage device is preferably linked to a central control unit. The predetermined threshold value can be, for example, 2 or 3. It is obvious to a person skilled in the relevant art that other threshold values are also possible depending on what power consumption will be tolerated during the successive interrogations.

According to a further embodiment a re-referencing of the capacitive sensor will be ordered by the central control unit during the static phase of the manually operated grip's being operated. It is thereby insured that on receiving a re-referencing instruction signal from the central control unit the capacitive sensor will recalibrate itself or, as the case may be, reset its zero position in such a way as to effect matching to the static condition.

A re-referencing instruction signal will preferably be sent by the central control unit to the capacitive sensor for the purpose of re-referencing the same each time a door contact condition changes, for example when the motor vehicle door is closed. False triggering due to, say, closing of the vehicle door will be prevented thereby.

According to a further exemplary embodiment for example the exterior mirrors will be folded in, the door locking device activated, side windows closed, and/or further changes in the motor vehicle's condition effected in the event of a case of positive data identification when the manually operated grip is operated for the purpose of closing a vehicle door. Analogously, for example the exterior mirrors will be folded out, the door locking device deactivated, side windows opened, and/or further changes in the motor vehicle's condition effected in the event of a case of positive data identification when the manually operated grip is operated for the purpose of opening the vehicle door.

A plurality of capacitive sensors are preferably provided in the motor vehicle, with, for example, in each case one sensor being located on each door or handle flap, or suchlike.

Following operating of the manually operated grip and associated triggering of a data identification interrogation, a check will for example be carried out by the central control unit to determine if there are any unused data carriers belonging to the operator in the motor vehicle, for example data carrier cards in the motor vehicle's glove compartment, with, if there are, said data carriers being blanked and not taken into account for the purpose of the remainder of the method. False triggering due to data carriers left unintentionally in the motor vehicle will be prevented thereby.

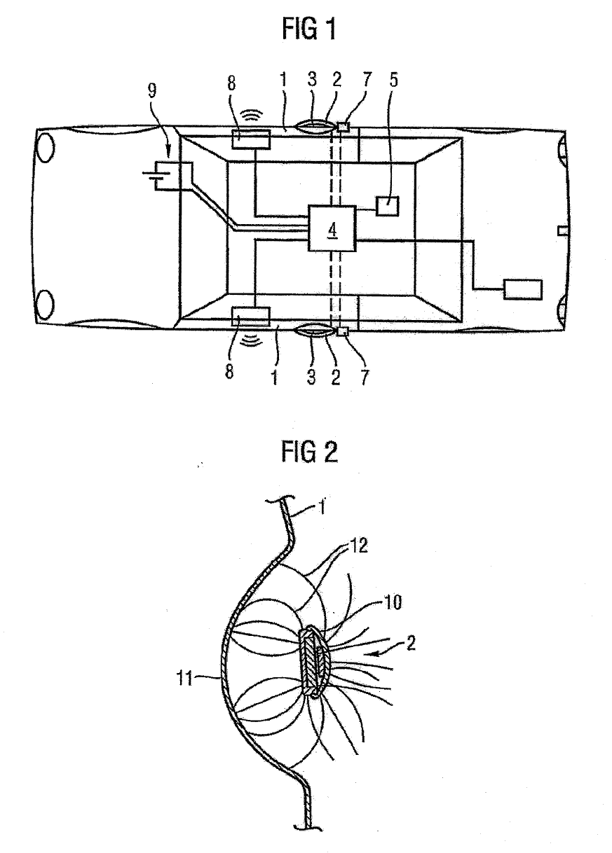

FIG. 1 is a schematic view of a motor vehicle having an integrated passive access system embodied solely by way of example as a locking system for locking or, as the case may be, unlocking a vehicle door. As can be seen from FIG. 1, preferably each door 1 has in each case a door handle containing a manually operated grip 2. The manually operated grip 2 can be embodied as, for example, a bow-type or flap-type grip containing a capacitive sensor 3. Running from the manually operated grips 2 or, as the case may be, the door handles are printed conductors that connect the respective capacitive sensors 3 to a central control unit 4. A signal will be sent from the capacitive sensor 3 via said printed conductors to the central control unit 4 if a hand approaches the gap between the manually operated grip 2 and the door 1. In the central control unit 4 a signal of said type will trigger a data interrogation of a data carrier (not shown) associated with the operator, with the central control unit 4 passing the signals on via the printed conductors to a plurality of send/receive units 8 that convey the data interrogation to the data carrier electromagnetically.

In the data carrier the command, for example, to output data is intercepted via an antenna and forwarded to a receiver of the data carrier. The receiver passes the signal on to a data unit of the data carrier which conveys the data requiring to be interrogated to the send/receive units 8 in the motor vehicle via a transmitter and the antenna of the data carrier.

The send/receive units 8 pass the received data on to the central control unit 4 via printed conductors. The data supplied by the data carrier is compared in the central control unit 4 with the identification data stored in a storage device 5 linked to the central control unit 4. In the case of positive data identification (acknowledgement of access authorization) the central control unit 4 will, by means of suitable connections, pass a signal changing the manually operated grips 2 from an inoperative to an operative mode on to the locking device 7 for unlocking it. In said operative condition of the manually operated grips 2 it will be possible to open the locking devices 7 by operating the manually operated grips 2.

The locking system, the central control unit 4, and the other operative electric components are preferably powered from the car battery 9 present in the motor vehicle.

FIG. 2 is a lateral cross-sectional view of a manually operated grip 2 and of a part of the motor vehicle door 1. As can be seen from FIG. 2, the manually operated grip 2 of the door handle has a first electrode 10 and the area of the door handle on the motor vehicle side has a second electrode 11 between which electrodes the electric field 12 is propagated.

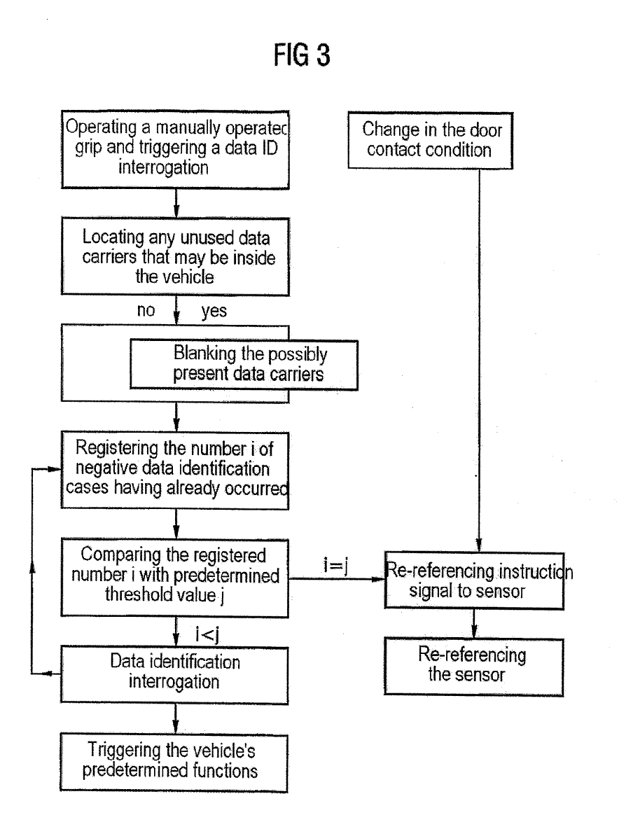

A method for preventing false triggering of said type of access system or, as the case may be, locking system according to a preferred exemplary embodiment of the present invention is explained in more detail below with reference to FIG. 3.

If there is a change in the electric field 12 shown in FIG. 2 between the two electrodes 10 and 11 of the door handle due to, for instance, the engagement of fingers, electronic circuitry will, as already mentioned above, register the change in capacitance and transform said change into an instruction pulse that will be sent via suitable leads to the central control unit 4. The instruction pulse generated by said electronic circuitry triggers a data identification interrogation of a data carrier associated with the operator in the central control unit 4.

In a further method step the central control unit 4 checks, for example when the motor vehicle door has been locked from outside, to what extent further unused data carriers associated with the operator are located inside the motor vehicle, for instance in the glove compartment. Any data carriers associated with the operator that are located inside the motor vehicle will be blanked by the central control unit 4 so that they will not be taken further into account during further method steps. Undesired identification data of data carriers of said type can be advantageously blanked thereby.

The central control unit 4 then preferably checks how often unsuccessful interrogations or, as the case may be, cases of negative data identification have already occurred within a predetermined, elapsed length of time. There will be a negative case of data identification when an interrogation of the central control unit 4 indicates there is no identification provider or, as the case may be, data carrier by the motor vehicle, with, where applicable, the data carriers undesirably present inside the motor vehicle advantageously not being taken into account, as has already been explained above.

The central control unit 4 is preferably linked to a storage device 5 in which are stored, in particular, the predetermined length of time for checking the number i of cases of negative data identification having already occurred and a predetermined threshold value j. The threshold value j is preferably 2 or 3 and indicates the maximum number of identification interrogations to be performed by the central control unit 4 before the capacitive sensor 3 is re-referenced, which is described in more detail further on.

According to an ensuing method step, the central control unit 4 compares the registered number i of cases of negative data identification having already occurred during the predetermined length of time with the threshold value j pre-stored in the storage device 5. A threshold value j of 2 is assumed for the explanations that follow, although threshold values differing therefrom are, of course, also possible.

If a comparison by the central control unit 4 indicates that the number i of cases of negative identification having already occurred is below the stored threshold value j of 2, then the central control unit 4 will perform a further data identification interrogation.

If, on the other hand, the comparison indicates that the number i of cases of negative identification having already occurred corresponds to the stored threshold value j of 2, then the central control unit 4 will send a re-referencing instruction signal to the respective capacitive sensor 3 in order to initialize selective re-referencing of said adaptive capacitive sensor 3.

During the static phase of operating, the capacitive sensor 3 is thus instructed by means of the received re-referencing instruction signal to independently recalibrate itself or, as the case may be, independently recalibrate its zero position so that, for example, any humidity or snow that may be covering the sensor area will not cause false triggering of certain changes in condition such as, for instance, unlocking or locking of the motor vehicle door 1, folding in or out of side mirrors, raising or lowering of windows, or suchlike. Owing to said re-referencing of the capacitive sensor 3 the condition of triggering due to, for example, the humidity or snow located in the sensor area will henceforth cease to be met and the sensor 3 will no longer detect operating. There will hence also be no energy-consuming data identification interrogation, as a result of which the total energy consumption will be substantially reduced.

As can further be seen from FIG. 3, specific functions of the motor vehicle will be triggered by the central control unit 4 in the event of a positive data identification interrogation. As already explained above, that can relate to locking or unlocking of the door, folding out or in of exterior mirrors, opening or closing of windows, and/or further changes in a vehicle's condition.

As is shown additionally in FIG. 3, the capacitive sensor 3 can also be re-referenced after any change in the door contact condition so that, for example, the associated capacitive sensor or, as the case may be, capacitive sensors 3 will be re-referenced each time the door 1 has been closed in such a way that no false triggering will take place through closing of the door 1.

The present invention thus provides a method by means of which false triggering of a passive access system can be prevented simply and economically. Said access system will, thanks to the inventive method, continue to retain its functioning capability even in the event of disruptions to the electric field due to, say, rain or snow or other disruptive variables. False triggering due to disruptive variables of said type will, according to the inventive method, require an increased quiescent current for a brief period only, namely while the data identification interrogations are being performed as often as accords with the predetermined threshold value, when there is no identification provider or, as the case may be, data carrier associated with the motor vehicle by said vehicle. On completion of predetermined interrogation cycles the access system will be restored to the idle condition in which the power consumption is only low. Discharging of the vehicle battery can advantageously be prevented thereby without having to forego permanent functioning capability on the part of the access system.

Although described in the foregoing with reference to preferred exemplary embodiments, the present invention is not restricted thereto but is open to multifarious modifications.

What is claimed is:

1. A method for preventing false triggering of a passive access system in the motor vehicle domain, with said access system having at least one manually operated grip on the vehicle side and at least one capacitive sensor that is situated in the vicinity of said manually operated grip, is linked to a central control unit, and triggers a data identification interrogation of a data carrier associated with the operator by the central control unit when the manually operated grip is operated, with said method comprising the following method steps:
registering the number of cases of negative data identification having already occurred during a predetermined length of time by the central control unit;
comparing the registered number of cases of negative data identification with a predetermined threshold value by the central control unit; and
having a further data identification interrogation performed by the central control unit if the registered number of cases of negative data identification is below the predetermined threshold value or having a re-referencing instruction signal sent by the central control unit to the at least one capacitive sensor for the purpose of re-referencing the same if the registered number of cases of negative data identification equals the predetermined threshold value.

2. The method according to claim 1, wherein
the predetermined threshold value is pre-stored in a storage device linked to the central control unit.

3. The method according to claim 1,
the predetermined threshold value is 2 or 3.

4. The method according to claim 1, wherein
a re-referencing of the at least one capacitive sensor is ordered by the central control unit during the static phase of operating the manually operated grip.

5. The method according to claim 1, wherein
on receiving a re-referencing instruction signal from the central control unit the at least one capacitive sensor will recalibrate its zero position itself.

6. The method according to claim 1, wherein
a re-referencing instruction signal will be sent by the central control unit to the at least one capacitive sensor for the purpose of re-referencing the same each time a door contact condition changes.

7. The method according to claim 1, wherein
exterior mirrors will be folded in, a door locking device activated, side windows closed, and/or further changes in the motor vehicle's condition effected in the case of positive data identification when the manually operated grip is operated for the purpose of closing a vehicle door.

8. The method according to claim 1, wherein
exterior mirrors will be folded out, a door locking device deactivated, side windows opened, and/or further changes in the motor vehicle's condition effected in the event of a case of positive data identification when the manually operated grip is operated for the purpose of opening the vehicle door.

9. The method according to claim 1, wherein
a plurality of capacitive sensors are provided in the motor vehicle, with preferably in each case one sensor being located on each door, each handle flap, or suchlike.

10. The method according to claim 1, wherein
following operating of the manually operated grip and associated triggering of a data identification interrogation, a check is carried out by the central control unit to determine if there are any unused data carriers belonging to the operator in the motor vehicle, with, if there are, said data carriers being blanked and not taken into account during further method steps.

11. A system for preventing false triggering of a passive access system in the motor vehicle domain, comprising
at least one manually operated grip on the vehicle side and at least one capacitive sensor that is situated in the vicinity of said manually operated grip and linked to a central control unit, and triggers a data identification interrogation of a data carrier associated with the operator by the central control unit when the manually operated grip is operated,
wherein the control unit is designed:
to register the number of cases of negative data identification having already occurred during a predetermined length of time;
to compare the registered number of cases of negative data identification with a predetermined threshold value; and
to perform a further data identification interrogation if the registered number of cases of negative data identification is below the predetermined threshold value or send a re-referencing instruction signal to the at least one capacitive sensor for the purpose of re-referencing the same if the registered number of cases of negative data identification equals the predetermined threshold value.

12. The system according to claim 11, wherein
the predetermined threshold value is pre-stored in a storage device linked to the central control unit.

13. The system according to claim 11, wherein
the predetermined threshold value is 2 or 3.

14. The system according to claim 11, wherein
the central control unit is further designed to order a re-referencing of the at least one capacitive sensor during the static phase of operating the manually operated grip.

15. The system according to claim 11, wherein the capacitive sensor is designed, upon receiving a re-referencing instruction signal from s the central control unit, to recalibrate its zero position.

16. The system according to claim 11, wherein the central control unit is further designed to send a re-referencing instruction signal to the at least one capacitive sensor for the purpose of re-referencing the same each time a door contact condition changes.

17. The system according to claim 11, wherein the central control unit is further designed to cause folding in of exterior mirrors of the vehicle, activation of a door locking device, closing of side windows, and/or effecting further changes in the motor vehicle's condition in the case of positive data identification when the manually operated grip is operated for the purpose of closing a vehicle door.

18. The system according to claim 11, wherein the central control unit is further designed to cause folding out of exterior mirrors, deactivation of a door locking device, opening of side windows, and/or effecting further changes in the motor vehicle's condition in the event of a case of positive data identification when the manually operated grip is operated for the purpose of opening the vehicle door.

19. The system according to claim 11, wherein a plurality of capacitive sensors are provided in the motor vehicle, with preferably in each case one sensor being located on each door, each handle flap, or suchlike.

20. The system according to claim 11, wherein the central control unit is further designed, following operating of the manually operated grip and associated triggering of a data identification interrogation, to carry out a check to determine if there are any unused data carriers belonging to the operator in the motor vehicle, with, if there are, said data carriers being blanked and not taken into account during further method steps.
